(19) United States
(12) Patent Application Publication
(10) Pub. No.: US 2025/0381472 A1
(43) Pub. Date: Dec. 18, 2025

(54) GAME CONTROLLER ATTACHMENT FOR MOBILE DEVICES DURING GAMEPLAY

(71) Applicant: Hasbro, Inc., Pawtucket, RI (US)

(72) Inventors: Allison M. Jennings, Pawtucket, RI (US); Scott S. Clark, Barrington, IN (US); Michael Luther, Cumberland, RI (US)

(21) Appl. No.: 19/237,376

(22) Filed: Jun. 13, 2025

Related U.S. Application Data
(60) Provisional application No. 63/660,393, filed on Jun. 14, 2024.

(51) Int. Cl. A63F 13/24; A63F 13/92

(52) U.S. Cl. CPC A63F 13/24; A63F 13/92

(57) ABSTRACT

Disclosed herein are systems and associated methods of a game controller attachment for a mobile device for use during interactive gameplay. The game controller attachment allows the mobile device to be transformed into interactive gameplay objects such as gadgets from a game storyline. The game controller attachment includes conductive surfaces on one side of the game controller attachment and tactile controls on the other side of the game controller attachment. The tactile controls are interactive points that align with the phone's touch interface to provide hidden device screen contacts, such as buttons, spinning wheels, and/or sliding styluses. For example, a spinning wheel on the controller interacts with specific screen areas of the mobile device to determine outcomes in the game.

### CROSS-REFERENCE TO RELATED APPLICATION(S)

This application claims priority to, and the benefit of, U.S. Provisional Patent Application Ser. No. 63/660,393 filed on Jun. 14, 2024, incorporated herein by reference in its entirety.

### BACKGROUND

A game application is a software program designed to provide interactive entertainment on various electronic devices, such as computers, consoles, smartphones, and tablets. Game applications range from simple games, such as puzzles and card games, to complex, games with high-quality graphics and intricate storylines. Game applications can offer single-player or multiplayer modes, allowing users to play alone or compete and collaborate with others online.

A game controller, gaming controller, or simply controller, is an input device or input/output device used with video games or entertainment systems to provide input to a video game application. Game controllers allow players to control characters, objects, and events within the game. Modern gaming controllers often feature a combination of buttons, analog sticks, directional pads, and triggers, to provide a more immersive gaming experience. Game controllers are used across various gaming platforms, such as consoles, PCs, and mobile devices.

### BRIEF DESCRIPTION OF THE DRAWINGS

FIG. 1 is a diagrammatic view illustrating an example environment of a mobile device equipped with a game controller attachment, in accordance with one or more embodiments.

FIG. 2 is a diagrammatic view illustrating an example environment of various elements of a game controller attachment, in accordance with one or more embodiments.

FIG. 3 is a diagrammatic view illustrating an example support structure of a game controller attachment, in accordance with one or more embodiments.

FIG. 4A is an isometric view illustrating an example clip fastener of a game controller attachment, in accordance with one or more embodiments.

FIG. 4B is a front orthogonal view illustrating an example clip fastener of the game controller attachment of FIG. 4A, in accordance with one or more embodiments.

FIG. 5 is a flowchart illustrating a process for controlling a game application using a game controller attachment removably coupled to a mobile device, in accordance with one or more embodiments.

FIG. 6 is a flowchart illustrating a process for controlling a game application executing on a mobile device using a game controller attachment, in accordance with one or more embodiments.

FIG. 7 is a block diagram illustrating an example computer system, in accordance with one or more embodiments.

### DETAILED DESCRIPTION

Game controllers are important for engagement in games because game controllers provide players with a responsive and intuitive interface, allowing for interaction with the world in the game. The various input methods on game controllers, such as buttons, enable dynamic user control, heightening the user level of immersion by providing physical motions that correspond to in-game interactions, making the gameplay experience more vivid and compelling. The heightened level of control keeps players engrossed in the game, maintaining the player's interest and investment in the unfolding narrative and challenges. Similarly, toys are also important for gameplay because toys bridge the gap between imagination and reality, allowing users to bring their favorite narratives to life. Toys provide a tangible connection to characters and/or objects within worlds, which further fosters creativity, cognitive development, and social development. Toys also encourage shared play experiences among peers and family members, reinforcing social skills and collaborative play. Both gaming controllers and story-based toys provide immersive, interactive experiences that increase the overall enjoyment of gameplay. The integration of mobile devices as components in a game with additional physical components has seen significant growth in recent years. The trend is driven by the increasing use of mobile devices in daily life for people, which allows for more complex and interactive gaming experiences by combining digital and physical play.

Traditional mobile gaming setups make use of touchscreen interfaces that users operate directly. The interface from game to game is always merely their phone. In playing mobile games, it is difficult to imagine that the interface is anything other than their phone. Although separate Bluetooth controllers have become more common, the controllers still require the player to manage two separate devices, which can be cumbersome and less portable. Bluetooth controllers also lead to potential connectivity issues, detracting from the gaming experience that mobile users seek. Furthermore, traditional gaming setups do not incorporate physical attachments that integrate directly with the phone's interface. Traditional gaming setups are standalone units that do not interact directly with the mobile device's touch capabilities. The separation limits the potential for game designs that incorporate both physical and virtual elements within the game. Moreover, mobile devices are typically designed with minimalist aesthetics that do not easily accommodate add-ons or attachments. For example, devices with smooth surfaces and minimal physical ports leave little room for securely attaching external accessories. Mobile attachments have limited compatibility within a narrow range of phone models.

To address the limitations of traditional gaming setups, this document discloses methods, systems, and apparatuses (hereinafter an “entertainment system”) for a game controller attachment for a mobile device for use during interactive gameplay. The game controller attachment allows the mobile device to be transformed into interactive gameplay objects such as gadgets from a game storyline. The game controller attachment includes conductive surfaces on one side of the game controller attachment and corresponding tactile controls on the other side of the game controller attachment. The tactile controls are interactive points that align with the phone's touch interface (e.g., display screen) to provide hidden device screen contacts, such as buttons, spinning wheels, and/or sliding styluses. For example, a spinning wheel on the controller interacts with specific screen areas of the mobile device to determine outcomes in the game.

In some embodiments, the game controller attachment coordinates with the mobile device's display screen to illuminate sections of the game controller attachment through illumination of the display screen based on gameplay scenarios for a more immersive experience. Transparent elements of the game controller attachment allow for screen visibility during illuminating portions of gameplay. In some embodiments, the game controller attachment is adjustable with ratchets or elastic straps for a secure fit for a variety of device sizes.

The entertainment system addresses the challenges of traditional gaming setups by transforming the mobile device into interactive gameplay objects, such as gadgets from a game storyline. By integrating the game controller attachment with the phone's touch interface, the controller provides precise and responsive inputs directly on the device. The adjustable nature of the game controller attachment ensures a secure fit across various phone models, addressing the compatibility issues of traditional add-ons. The entertainment system not only enhances the gaming experience by merging physical and digital interactions but also maintains the portability and ease of use that mobile gamers desire.

While the present technology is described in detail for use with gameplay, the technology could be applied, with appropriate modifications, to improve device attachments of other applications, making the technology a valuable tool for diverse applications beyond gameplay. The examples provided in this paragraph are intended as illustrative and are not limiting. Any other application or game referenced in this document, and many others unmentioned are equally appropriate after appropriate modifications.

The invention is implemented in numerous ways, including as a process; an apparatus; a system; a composition of matter; a computer program product embodied on a computer-readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description that references the accompanying figures follows. The scope of the invention is limited only by the claims and the invention encompasses numerous alternatives, modifications, and equivalents. Numerous specific details are set forth in the following description in order to provide a thorough understanding of the disclosure. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### Sensor-Driven Motion Detection for Mobile Devices

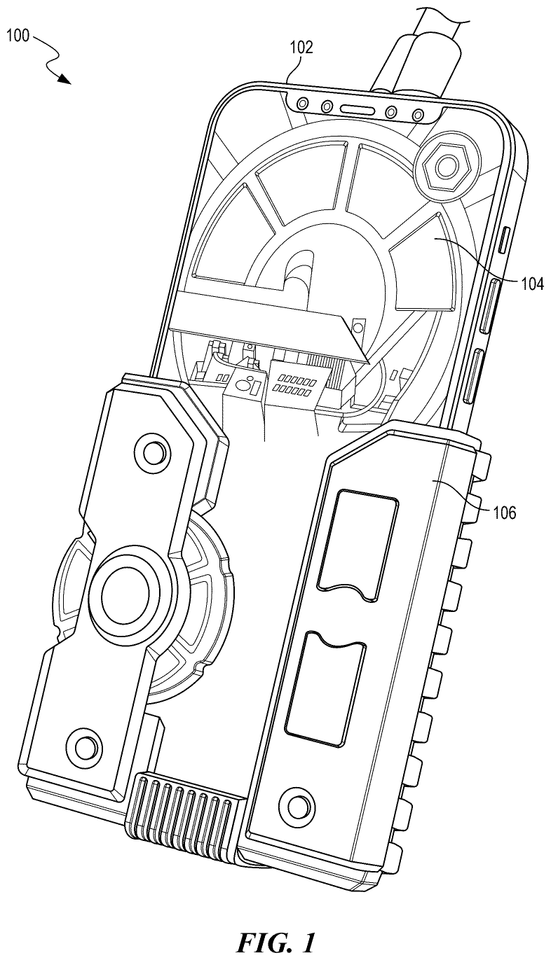

FIG. 1 is a diagrammatic view illustrating an example environment 100 of a mobile device equipped with a game controller attachment, in accordance with one or more embodiments. Environment 100 includes device 102, display screen 104, and game controller attachment 106. In some embodiments, implementations of example environment 100 include different and/or additional components or are connected in different ways.

Device 102 is a mobile computing device that provides an interface for the user. Examples include smartphones, tablets, and handheld gaming consoles. In some embodiments, device 102 includes computing devices capable of running gaming applications. Display screen 104 is the visual interface of device 102, providing the user with a graphical representation of the game and other applications. Display screen 104 is a high-resolution touch-sensitive screen that supports multi-touch inputs, enabling users to interact directly with the on-screen content through gestures such as tapping, swiping, and pinching.

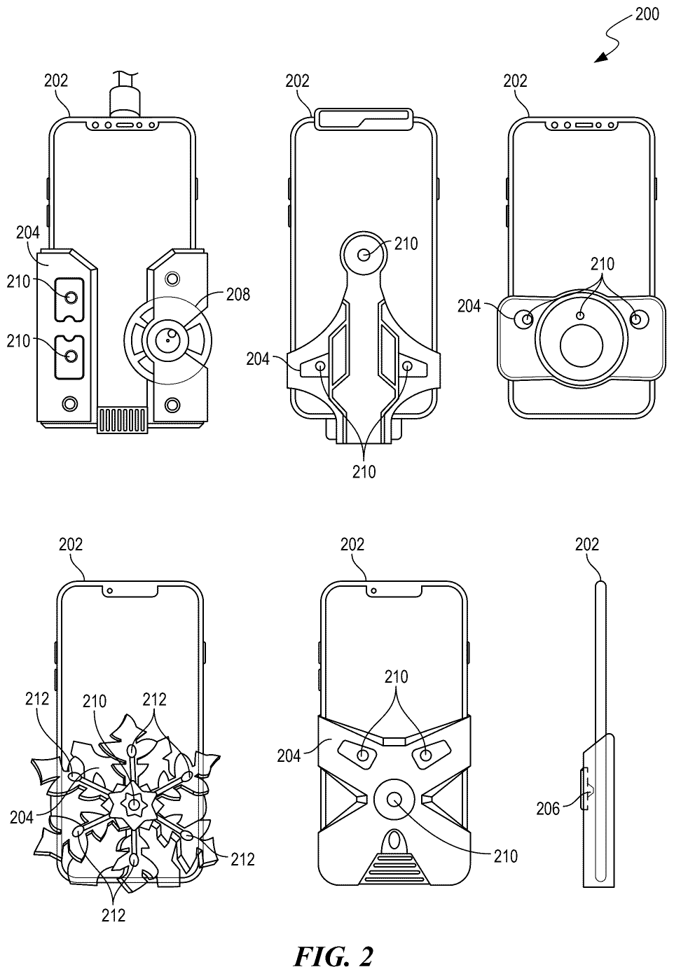

The display screen 104 displays the game graphics and responds to both touch inputs and those generated by the game controller attachment 106. The game controller attachment 106 includes various tactile elements such as buttons, spinning wheels, and sliding styluses, which align with the device's touch interface via hidden screen contacts. The game controller attachment 106 includes conductive surfaces that interact with the display screen to enable input through the tactile elements of the game controller attachment 106 and includes transparent elements to allow screen illumination during gameplay. The game controller attachment 106 fits securely around device 102, with adjustable features such as ratchets or elastic straps ensuring compatibility with various phone models. The game controller attachment 106 includes conductive surfaces and transparent elements. The game controller attachment 106 buttons, spinning wheels, and/or styluses align with specific areas of the display screen 104, enabling hidden screen contacts and illuminated interactions based on gameplay scenarios. Examples of the gaming controller attachment 106 are described in further detail with reference to gaming controller attachment 204 in FIG. 2.

In some embodiments, a game is actively running on the device 102, and the game controller attachment 106 is synchronized or paired with the corresponding software to enable interactive gameplay. Methods of synchronizing the game controller attachment 106 with the corresponding software are discussed with reference to FIG. 2. Once synchronized, the tactile controls and conductive surfaces provided by the game controller attachment 106 complement the touchscreen interface of the device 102. In some embodiments, when a player presses a button or interacts with a tactile control on the game controller attachment 106, the corresponding action is registered by the game software, triggering appropriate responses within the game environment. For example, the game controller attachment 106 enables players to navigate game menus, execute in-game actions, and/or control character movements. The real-time synchronization ensures that players are able to transition between physical and digital interactions, enhancing immersion and gameplay flow.

In some embodiments, one side of the housing of the game controller attachment that includes the set of conductive surfaces faces proximate to the display screen of the mobile device when the game controller attachment is coupled to the mobile device. Another side of the housing that includes the set of tactile controls faces distal to the display screen when the game controller attachment is coupled to the mobile device. Both sides of the housing are positioned on opposite sides of the housing structure, thus enabling direct interaction with the mobile device's touch-sensitive display and user-accessible controls.

The conductive surfaces on the first side of the housing may be positioned to align with specific touch-sensitive areas of the display screen, enabling the game controller attachment to simulate touch inputs at predetermined locations. The conductive surfaces include materials such as conductive films, pressure-reactive materials, or capacitive touch elements that are enabled to interact with the mobile device's capacitive touch sensors. When a user interacts with the tactile controls on one side of the housing, the corresponding conductive surfaces on the first side create electrical connections with the display screen, translating physical user inputs into digital signals that the mobile device uses to generate game commands (as discussed further in FIGS. 2-6). The tactile controls on the side of the housing include raised buttons, textured surfaces, or mechanical elements that provide tactile feedback to users during gameplay.

FIG. 2 is a diagrammatic view illustrating example environment 200 of various elements of a game controller attachment, in accordance with one or more embodiments. Environment 200 includes device 202, game controller attachment 204, screen contact 206, spinning wheel 208, buttons 210, and sliding stylus 212. Device 202 is the same as or similar to device 102 in FIG. 1. Game controller attachment 204 is the same as or similar to game controller attachment 106 in FIG. 1. In some embodiments, implementations of example environment 200 include different and/or additional components or are connected in different ways.

Device 202, such as a mobile device, operates as a gaming platform or a portion of the gaming platform that runs a gaming application (e.g., a game). For example, the gaming platform includes both a software application on device 202 and a physical component (e.g., gaming board, gaming board pieces, figurines, dice, cards). The game controller attachment 204 provides tactile controls and interactive elements that complement the device's 202 touchscreen interface (e.g., display screen 104).

In some embodiments, the gaming platform includes interactive physical elements identifiable by the device by, for example, scanning a portion of the physical element. In some examples, the game on the gaming platform includes physical elements (e.g., paper cards) embedded with identifiers (e.g., QR codes, barcodes or other distinctive printed markings). The components represent characters, objects, and/or other game elements, each encoded with unique identifiers. When players encounter new elements or prompts within the game, the players are prompted to scan corresponding identifiers of the physical elements using a camera (e.g., of the device 202). Upon scanning, manipulating, or receiving other interactions, the game software on the device 202 interprets the identifier data and triggers relevant in-game actions or events. For instance, if a player encounters a new character card with a QR code on a physical component of the gaming platform (e.g., a game board), scanning the code prompts the game software on the device 202 to introduce a new mission, unlock additional content, and/or initiate interactions with the scanned character.

Screen contact 206 refers to a hidden button or touch-sensitive area on the attachment that aligns with specific areas of the device's 202 touchscreen interface. In some embodiments, the location of screen contact 206 corresponds to tactile control areas of the device's 202 touchscreen interface, such as spinning wheel 208, buttons 210, and sliding stylus 212. Conductive materials (e.g., conductive film) or pressure-reactive materials are used on the game controller attachment 204 at the location of the screen contact 206.

The conductive material on the game controller attachment 204 allows the device 202, at the location of the screen contact 206, to detect changes in electrical capacitance when touched via the conductive material on the game controller attachment 204. In some implementations, a surface capacitive touch sensor, which is a transparent conductive layer placed over the device 202 and adjacent to the surface of the game controller attachment 204, forms an electrode grid. When a user's finger touches the game controller attachment 204 at the location of the screen contact 206, the conductive material of the game controller attachment 204 interacts with the capacitive touch sensor and creates a disturbance in the electrostatic field, which is detected by the device 202 and interpreted as a touch input. In some implementations, the device 202 includes projected capacitive touch sensors, another type of capacitive touch sensor, and uses a grid of electrodes embedded in a transparent substrate, with each electrode capable of detecting changes in capacitance independently. Pressure-reactive materials, on the other hand, respond to applied pressure, enabling users to trigger actions on the device 202 by pressing on specific areas of the game controller attachment 204. Pressure-reactive materials change resistance or conductivity in response to applied pressure.

In some embodiments, there is a calibration process when the game controller attachment 204 is attached to the device 202 to ensure accurate alignment and responsiveness of the screen contacts. For example, the device 202 adjusts sensitivity levels, activation thresholds, and verifies consistency across different touch points on the game controller attachment 204. For example, the device 202 prompts the user to interact with various touch-sensitive areas on the game controller attachment, such as buttons, spinning wheels, and sliding styluses. As the user touches each area, the device 202 adjusts the device's 202 sensitivity levels to accurately detect the touch inputs. For instance, if a button requires a lighter touch to register compared to a spinning wheel, the device 202 calibrates the sensitivity of the device 202 accordingly to ensure consistent performance across all inputs. Additionally, the device 202 adjusts activation thresholds to determine the minimum pressure required for a touch to register on the attachment. Adjusting activation thresholds ensures that users are able to activate the tactile controls with the appropriate amount of pressure, preventing accidental inputs while still maintaining responsiveness.

In some embodiments, the game controller attachment 204 includes adjustable mechanisms or modular components to accommodate different devices without compromising performance or usability. The adjustable features allow the attachment to be customized to fit different device sizes, shapes, and configurations, ensuring compatibility across a range of smartphones and tablets. The game controller attachment 204 includes adjustable elements such as ratchets, clips, elastic straps, or sliding mechanisms that are adjusted to fasten the attachment to devices of various dimensions. For example, a game controller attachment includes ratchets on the sides of the game controller attachment, allowing users to expand or contract the attachment's width to fit smartphones or tablets of varying sizes. When attaching the controller to a larger device, users loosen the ratchets to widen the attachment. Conversely, when attaching the controller to a smaller device, users tighten the ratchets to reduce the width. Additionally, in some embodiments, modular components are used to adapt the attachment to different device models, such as interchangeable grips or adapters.

In some embodiments, the housing includes stylizing elements configured to match a game aesthetic defining one or more visual elements corresponding to the game application. The stylizing elements include, for example, decorative surfaces, themed textures, character representations, color schemes, and so forth that correspond to visual elements of the game application. The decorative surfaces include, for example, embossed patterns, raised reliefs, or surface treatments that mirror design motifs from the game application. In some embodiments, the themed textures provide tactile feedback that simulates materials or environments represented in the game application, such as rough stone textures for dungeon-themed games or metallic finishes for futuristic settings. The character representations include, for example, three-dimensional figurines, character silhouettes, or iconic symbols that represent protagonists, antagonists, or other objects from the game application. The color schemes include, for example, specific color palettes that match the visual branding and/or atmospheric elements of the game application. The stylizing elements are positioned on exterior surfaces of the housing.

Tactile controls of the device 202 include controls such as spinning wheel 208, buttons 210, and sliding stylus 212. In some embodiments, the gaming platform, via the screen of the device 202, displays a representation of instructions defining the in-game actions that correspond to particular motions on the tactile controls. For example, the screen shows that to jump, a certain button on the game controller attachment 204 must be pressed. Spinning wheel 208, in some embodiments, includes the position of the screen contact 206 in a specific section of the spinner, (e.g., the “2” portion in a spinning wheel 208 with six sections numbered 1 through 6). When the user interacts with the spinning wheel 208, the device's software determines the final position based on the initial position of the screen contact 206 (e.g., the “2” portion) and the resulting position of the screen contact 206. Spinning wheel 208 includes, in some embodiments, a rotary encoder mechanism in the game controller attachment. Spinning wheel 208 includes, in some embodiments, a disc with evenly spaced markings around the spinning wheel's 208 circumference and sensors that detect changes in position as the wheel rotates. When a user interacts with the spinning wheel, the sensors detect the rotational movement and translate the rotational movement into digital signals, which are then processed by the device's software to determine the direction and speed of rotation.

Buttons 210 are placed on the attachment to align with specific areas of the device's 202 touchscreen interface. Behind each button is a screen contact 206 that detects when the button is pressed. When a user presses button 210, the game detects the button press and registers the button press as a touch on the corresponding area of the screen. For example, if button 210 is aligned with the “jump” action in a platformer game, pressing the button 210 triggers the game to register a touch on the corresponding area of the screen designated for jumping. As a result, the game character jumps in response to the button press on the game controller attachment 204.

Sliding stylus 212 is within a sliding mechanism that consists of a track or rail along which the sliding stylus 212 slides back and forth. The sliding stylus 212 is attached to a carriage or platform that rides along the track, allowing users to extend and retract the stylus as needed. When a user extends the stylus, the game detects the extension and registers the extension as a sliding motion on the corresponding area of the screen. For example, if the user extends the sliding stylus 212 to draw a line in the game, the game registers the movement of the sliding stylus 212 and translates the movement into a drawing action on the screen. The sliding stylus 212, in some embodiments, allows users to slide the stylus in multiple directions. For example, sliding the stylus upwards zooms in on the map, while sliding the stylus downwards zooms out. Additionally, for example, diagonal movements are used for specific actions, such as rotating an object or character within the game. In some embodiments, the sliding stylus 212 allows for multiple sequential slides as part of a single command or action. For instance, in order to execute a ground slam, a player slides the stylus upward to initiate a jump, then quickly slides the stylus downwards to perform a slamming motion.

In some embodiments, the game controller attachment 204 includes elements that are more transparent than others corresponding to specific areas of the screen. When certain in-game events or scenarios occur, the software triggers the illumination of the specific areas of the screen corresponding to the elements on the game controller attachment 204. For example, if a character in the game activates a flashlight, the game illuminates an area of the screen that is covered by a corresponding transparent element of the game controller attachment 204, mimicking the effect of a flashlight beam. The illumination of the game controller attachment 204 provides users with visual cues and feedback that heighten engagement during gameplay.

In some embodiments, the game application uses accelerometer and/or gyroscope sensors integrated within the mobile device to receive information associated with a device's orientation, movement, and rotation in three-dimensional space. The game application uses the sensor data to enable motion-based controls, thereby enabling users to perform actions such as steering, aiming, or balancing by physically moving the mobile device. For instance, in a racing game, tilting the device left or right steers the vehicle, while in a first-person shooter, rotating the device adjusts the in-game camera view. The accelerometer and/or gyroscope data, in some embodiments, are used to detect specific gestures or movements, such as shaking the device to reload a resource or perform a special action within the game.

In some embodiments, the orientation of the mobile device, as detected by its sensors, dynamically adjusts the functionality of the physical controls on the game controller attachment. When the device orientation changes, such as rotating from portrait to landscape mode, the game application automatically reconfigures the mapping of the buttons 210 and sliding stylus 212 to maintain a control scheme. For example, the sliding stylus 212 adjusts from controlling vertical movement based on a vertical gesture relative to the mobile device in a portrait orientation to a vertical gesture relative to the mobile device in a landscape orientation. This adaptive control mapping ensures that the user experience remains consistent and ergonomic regardless of how the device is held or positioned.

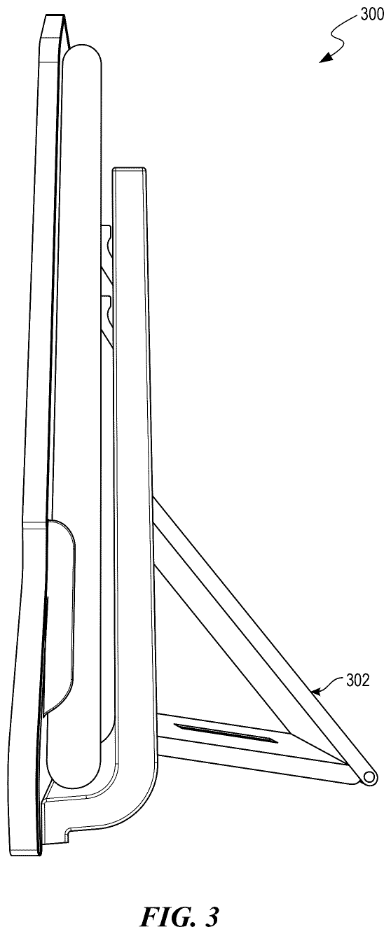

FIG. 3 is a diagrammatic view illustrating an example environment 300 of an example support structure of a game controller attachment, in accordance with one or more embodiments. The game controller attachment cradles the mobile device in an upright position using a stand 302. The mobile device is the same as or similar to device 102 in FIG. 1. The game controller attachment is the same as or similar to game controller attachment 106 in FIG. 1. In some embodiments, implementations of example environment 300 include different and/or additional components or are connected in different ways.

The housing of the game controller attachment, in some embodiments, includes a support structure that elevates the mobile device at an angle relative to a surface on which the game controller attachment is placed. The game controller attachment includes a main body that cradles the mobile device and an integrated stand 302 extending from the rear of the main body. The stand 302, in some embodiments, includes multiple angled segments that form a support structure, thereby enabling the game controller attachment to maintain the attached mobile device at a particular viewing angle. In some embodiments, the support structure is positioned to orient a front-facing camera of the mobile device towards a user, and the front-facing camera is enabled to capture one or more images of the user at the angle (e.g., to be used in games that use facial recognition, gesture controls, or augmented reality).

In some embodiments, the angle is adjustable through use input (e.g., tilting the stand up or down). The stand is attached to the main body through, for example, a ratcheting system, a friction hinge, or a series of preset notches. By enabling users to modify the angle, the game controller attachment accommodates different player heights, lighting conditions, or personal preferences for screen visibility during gameplay. In some embodiments, the stand 302 is collapsible/foldable and folds flush against the back of the main body.

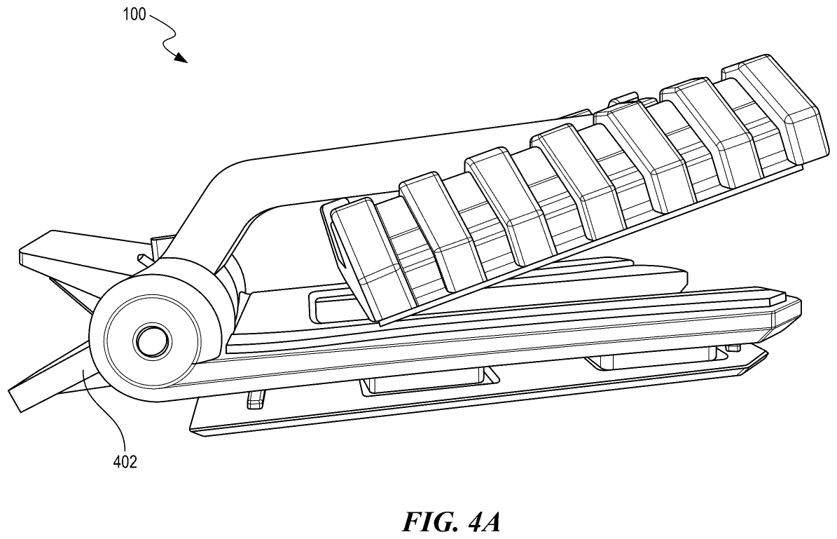

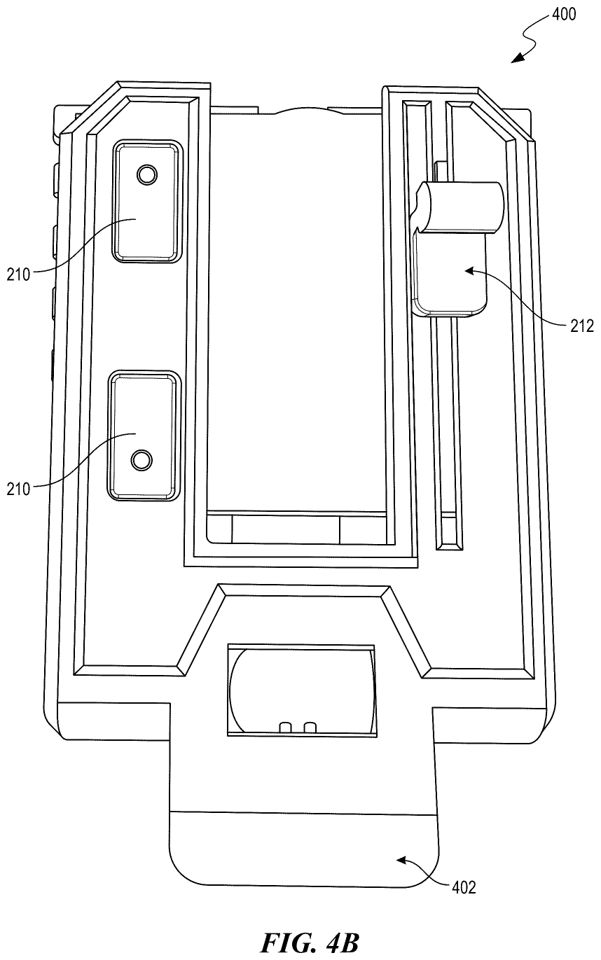

FIG. 4A and FIG. 4B illustrate different views of an example environment 400 of an example clip fastener of a game controller attachment, in accordance with one or more embodiments. The game controller attachment is the same as or similar to game controller attachment 106 in FIG. 1. In some embodiments, implementations of example environment 400 include different and/or additional components or are connected in different ways.

FIG. 4A is an isometric view illustrating the example environment 400 of the example clip fastener of the game controller attachment. The game controller attachment includes a clip 402 that operates as a fastener. In some embodiments, one or more portions of the housing includes a series of parallel, evenly spaced segments that create a ribbed or stepped appearance to provide a tactile grip surface and/or protection and space for the mobile device.

The clip 402 secures the game controller attachment to a mobile device. The clip 402 includes a base portion that extends from one end of the game controller housing and includes one or more gripping elements configured to engage with the edges or sides of a mobile device. In some embodiments, the clip 402 includes a pivoting element, such as a hinge, rotatable joint, or flexible member, to enable the clip 402 to adjust its angle relative to the main body of the game controller attachment, therefore accommodating mobile devices of varying thicknesses and form. The clip 402 includes, in some embodiments, adjustable tension elements, such as springs or elastomeric materials, to provide a consistent grip on the mobile device. In some embodiments, the clip 402 includes padding or cushioning materials at contact points to protect the mobile device from scratches or wear. The clip 402 includes, in some embodiments, a locking component to maintain a desired angle or position once adjusted.

FIG. 4B is a front orthogonal view illustrating the example environment 400 of the example clip fastener of the game controller attachment of FIG. 4A, in accordance with one or more embodiments. The game controller attachment in FIG. 4B includes buttons 210 and a sliding stylus 212. The buttons 210 and the sliding stylus 212 align with specific areas of the mobile device's touchscreen when secured by the clip 402. The clip 402 is used as an anchor to ensure that the conductive surfaces corresponding to the buttons 210 and sliding stylus 212 maintain contact with consistent areas of the touchscreen of the mobile device. As a user interacts with the buttons 210 or manipulates the sliding stylus 212, the clip 402 prevents misalignment that result in erroneous inputs.

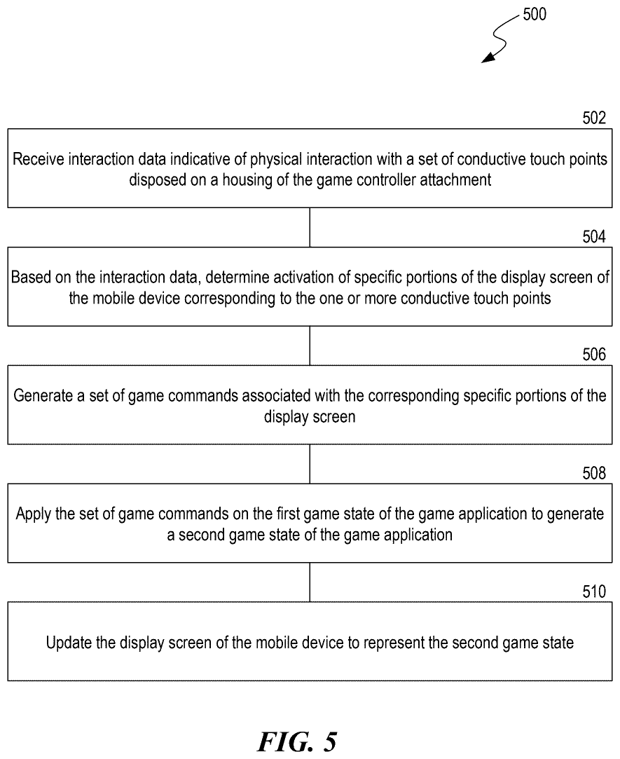

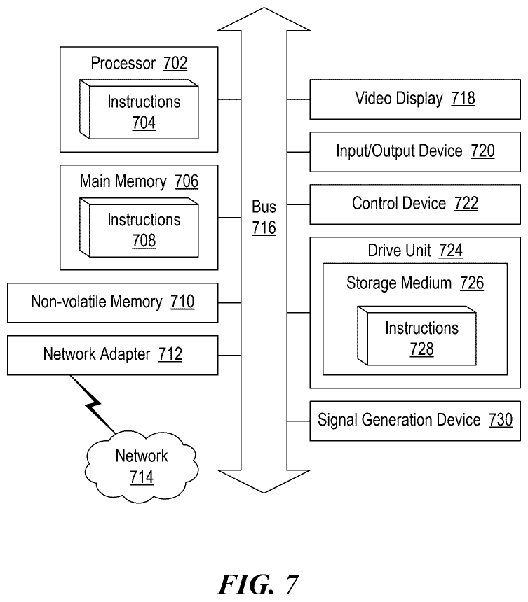

FIG. 5 is a flowchart illustrating a process 500 for controlling a game application using a game controller attachment removably coupled to a mobile device, in accordance with one or more embodiments. In some implementations, the process 500 is performed by components of example computer system 700 (e.g., the entertainment system) illustrated and described in more detail with reference to FIG. 7. Likewise, implementations can include different and/or additional steps or can perform the steps in different orders.

In operation 502, the game application receives interaction data indicative of physical interaction with a set of conductive touch points disposed on a housing of the game controller attachment. The housing include casing elements that structurally support the conductive touch points on the game controller attachment. The game controller attachment partially overlays a display screen of the mobile device, which displays a first game state of the game application. The first game state refers to a data structure storing values for game variables associated with character states, game environment states, and/or user interface component states. The set of conductive touch points includes a rotary wheel (e.g., a spinning wheel), control buttons, and/or a sliding element (e.g., a stylus). In some embodiments, the game controller attachment includes a fastener (e.g., a ratchet, elastic strap, clip, sliding element) configured to secure the game controller attachment to the mobile device.

The interaction data is generated when a user physically manipulates one or more of the conductive touch points on the game controller attachment. For example, as shown in FIG. 1, the game controller attachment 106 includes various tactile elements that correspond to conductive touch points, enabling users to interact with the underlying display screen 104 through physical manipulation of the attachment. The first game state displayed on the display screen represents the current status of the game application, and indicates visual elements, character positions, game environment, user interface components, and/or any other graphical information relevant to the current gameplay situation.

In operation 504, based on the interaction data, the entertainment system determines activation of specific portions of the display screen of the mobile device corresponding to the one or more conductive touch points. In some embodiments, the entertainment system determines a presence of a set of electrical connections between one or more conductive touch points and corresponding portions of the display screen of the mobile device. When a user interacts with a conductive touch point, such as pressing one of the control buttons 210 shown in FIG. 2, the conductive material within the game controller attachment creates a disturbance in the electrostatic field of the display screen's capacitive sensors. The disturbance is detected by the mobile device and interpreted as a touch input at the specific location corresponding to the activated conductive touch point.

The rotary wheel is implemented as a disc (e.g., circular) with evenly distributed markings around its circumference. The markings operate as reference points and, in some embodiments, are visible to users. For a rotary wheel, the entertainment system determines the set of game commands by comparing (a) an initial position of a screen contact associated with the rotary wheel and (b) a resulting position of the screen contact associated with the rotary wheel. The initial position of the screen contact associated with the rotary wheel 208 represents the starting point of user interaction, which corresponds to a specific marking or angular position on the disc. When a user begins to rotate the wheel, this initial position is used to determine subsequent movement. The resulting position represents the final location of the screen contact after the user completes their rotational input. By comparing these two positions, the entertainment system is enabled to determine the total angular displacement, direction of rotation (clockwise or counterclockwise), and/or the number of discrete steps or markings traversed during the interaction.

In some embodiments, the entertainment system detects (e.g., using a processor of the mobile device) a rotational speed of the spinning wheel. The entertainment system determines (e.g., using the processor) an in-game action based on the detected rotational speed. The entertainment system executes (e.g., using the processor) the determined in-game action within the game application. The entertainment system, for example, measures the time elapsed between position changes to calculate the velocity of rotation. For example, a slow rotation results in gradual character movement, while a rapid spin triggers an attack or quick navigation through menu options. The entertainment system, in some embodiments, categorizes different speed ranges to correspond to specific actions.

The sliding element refers to a linear input system such as a carriage attached to a track, where a stylus extends and retracts along the track via the carriage and enables users to perform sliding motions along a predetermined path. As the user manipulates the sliding element, the stylus maintains contact with specific areas of the touchscreen, thus creating a continuous or intermittent series of touch inputs that correspond to the stylus position along the track.

For a sliding element, the physical interaction includes multiple sequential slides (e.g., series of sliding motions performed in succession) of the sliding stylus. These sequential slides, in some embodiments, occur in the same direction, alternating directions, and/or in patterns. For example, a user performs a series of rapid back-and-forth slides to simulate a sawing motion, or executes multiple slides in the same direction to build up momentum for an in-game action. The set of game commands corresponding to the multiple sequential slides, in some embodiments, is a single game command. In some embodiments, the entertainment system implements timeout periods, minimum slide counts, or specific sequence requirements to distinguish between individual slide commands and combined gesture commands.

For control buttons, the entertainment system uses discrete press and release events to generate corresponding game commands. As shown in FIG. 2, the control buttons 210 are positioned on the game controller attachment 204 to align with specific touch-sensitive areas of the mobile device's display screen. Each control button 210 includes an underlying screen contact 206 that facilitates the electrical connection between the button and the display screen when pressed.

The control buttons 210, in some implementations, are implemented as physical buttons with tactile feedback, providing users with a click or depression sensation when activated. When a user presses a control button 210, the entertainment system detects the button activation through changes in electrical capacitance or pressure at the corresponding screen contact 206 location. The entertainment system distinguishes, in some embodiments, between different types of button interactions, including single presses, double presses, long presses, and simultaneous multi-button combinations. Each type of interaction is enabled to trigger different in-game actions. In some embodiments, the entertainment system tracks whether buttons are currently pressed or released to enable actions that depend on sustained button activation. For example, holding down a button causes a character to run continuously, while releasing the button stops the running action.

In operation 506, responsive to determining the activation of the specific portions of the display screen, the game application generates a set of game commands associated with the corresponding portions of the display screen. The set of game commands are structured to execute a set of in-game actions on the first game state. The game application, in some embodiments, maintains a mapping schema that correlates specific screen coordinates or regions with corresponding game commands. For example, as shown in FIG. 2, when a user interacts with the rotary wheel 208 on the controller attachment 204, the resulting electrical connection at the corresponding portion of the display screen generates commands related to rotational actions such as character turning, camera rotation, or menu navigation.

The game application is enabled to validate that generated commands are appropriate for the current game state by checking whether certain actions are currently available, whether the player character is in a state that allows for specific actions, or whether environmental conditions permit the execution of particular commands. In some embodiments, the entertainment system (e.g., via the game application or processor of the mobile device) detect simultaneous interactions with multiple conductive touch points, and combines the interaction into a single game command. For example, a user simultaneously presses two of the control buttons 210 to trigger a special ability.

In operation 508, the entertainment system applies the set of game commands on the first game state of the game application to generate a second/modified game state of the game application. For example, if a user rotates the rotary wheel 208 shown in FIG. 2, the corresponding game command instructs the game to rotate the player character or camera view. The entertainment system updates the character's orientation angle or camera position values within the game state data structure to create a second game state that reflects this rotational change.

In operation 510, the entertainment system updates the display screen of the mobile device to represent the second game state. In some embodiments, one or more game commands cause illumination of a portion of the display screen that corresponds to one or more transparent portions of the game controller attachment. For example, the game controller attachment includes transparent elements (e.g., clear plastics, glass, or other translucent materials that permit light transmission) disposed within the housing, where the transparent elements maintain visibility of one or more portions of the display screen while the game controller attachment is coupled to the mobile device.

When certain game events occur or specific commands are executed, the entertainment system activates colors, patterns, or other animations on portions of the display screen 104 that align with transparent sections of the game controller attachment 106. This creates the illusion that the controller itself is illuminated or that light is emanating from specific components of the attachment. The illumination effects may vary in intensity, color, pattern, and timing based on the specific game events or commands that trigger them. For example, a successful action triggers a bright green illumination, while a warning or danger situation causes red pulsing lights.

In some embodiments, the entertainment system causes display of, on the display screen, instructions defining one or more in-game actions corresponding to the physical interaction. As shown in FIG. 1, the display screen 104 presents textual, graphical, and/or animated instructions that demonstrate how specific physical interactions with the game controller attachment 106 correspond to particular in-game actions.

To adjust a level of sensitivity for the set of conductive touch points, the entertainment system triggers one or more operations to determine the sensitivity automatically when the game controller attachment is first connected to the mobile device, or it may be triggered manually. The entertainment system enables users to (or automatically) performs a series of predefined interactions with each type of conductive touch point on the game controller attachment. During the calibration interactions, the game platform identifies calibration metrics such as signal strength, response time, and consistency. The entertainment system, in some embodiments, refine the calibration based on ongoing usage patterns (e.g., success rate of intended actions, the frequency of accidental activations, and the consistency of user inputs).

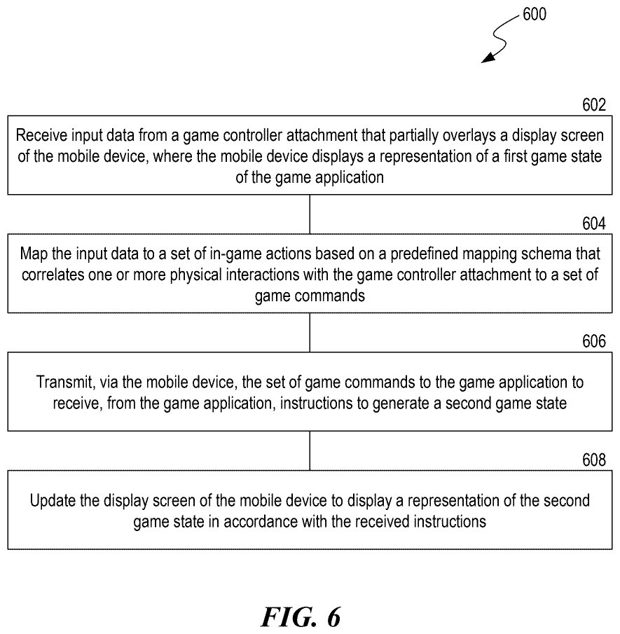

FIG. 6 is a flowchart illustrating a process for controlling a game application executing on a mobile device using a game controller attachment, in accordance with one or more embodiments. In some implementations, the process 600 is performed by components of example computer system 700 (e.g., the entertainment system) illustrated and described in more detail with reference to FIG. 7. Likewise, implementations can include different and/or additional steps or can perform the steps in different orders.

In operation 602, a processor of the mobile device receives input data from the game controller attachment, where the game controller attachment provides a set of conductive touch points (i.e., the set of conductive touch points in FIG. 5) for tactile control of a game application. As discussed further above in FIGS. 1-6, the game controller attachment partially overlays a display screen of the mobile device that displays a first game state of the game application. In some embodiments, the processor determines or otherwise obtains a predefined pressure threshold for a touch to register on the game controller attachment.

In operation 604, the entertainment system maps the input data to a set of in-game actions based on a predefined mapping schema that correlates one or more physical interactions (e.g., diagonal or other movement with a stylus, spinning of a wheel, push of a button) with the game controller attachment to a set of game commands that include directional input, action triggers, and/or menu selections that are used to execute the set of in-game actions on the first game state. Examples of mapping implementations are further discussed with reference to FIGS. 1-6, where the various control elements shown in FIG. 2 demonstrate different types of physical interactions that correspond to different types of mappings. For example, the entertainment system accesses, by the processor, a lookup table that correlates specific physical interactions with predefined in-game actions. The entertainment system identifies, by the processor, a matching entry in the lookup table for the received input data, and selects a corresponding in-game action based on the matching entry.

In operation 606, the entertainment system transmits, via the mobile device, the set of game commands to the game application to receive, from the game application, instructions to render a second game state. In operation 608, the entertainment system updates the display screen of the mobile device to represent the second game state in accordance with the received instructions. Examples of display updates are further discussed with reference to FIGS. 1-6, where the display screen 104 shown in FIG. 1 operates as the visual interface for presenting the game content.

In some embodiments, if the processor detects a change in orientation of the mobile device, the processor adjusts the mapping of the input data based on the detected change in orientation. The adjustment of input mapping based on orientation changes ensures that the game controller attachment maintains intuitive and consistent control behavior regardless of how the user holds or positions the mobile device. For example, if the user rotates the device from portrait to landscape orientation, the entertainment system automatically adjusts the directional controls to maintain logical correspondence between physical movements and on-screen actions.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in the specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite the change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples: alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for,” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

We claim:

1. A computer-implemented method for controlling a game application executing on a mobile device using a physical game controller attachment removably mounted onto the mobile device, the computer-implemented method comprising:
receiving, by the game application, interaction data indicative of physical interaction with a set of conductive touch points disposed on a housing of the game controller attachment,
wherein the housing of the game controller attachment comprises casing elements configured to structurally support the set of conductive touch points on the housing,
wherein the game controller attachment partially overlays a display screen of the mobile device which displays a representation of a first game state of the game application, and
wherein the set of conductive touch points includes at least one of a rotary wheel, control buttons, or a sliding element;
based on the interaction data, determining activation of specific portions of the display screen of the mobile device corresponding to the one or more conductive touch points;
responsive to determining the activation of the specific portions of the display screen of the mobile device, generating, by the game application, a set of game commands associated with the corresponding specific portions of the display screen, wherein the set of game commands includes instructions to execute a set of in-game actions on the first game state;
applying the set of game commands on the first game state of the game application to generate a second game state of the game application; and
updating the display screen of the mobile device to display a representation of the second game state.

2. The computer-implemented method of claim 1, wherein one or more game commands cause illumination of a portion of the display screen that corresponds to one or more transparent portions of the game controller attachment, and wherein the transparent portions are configured to maintain visibility of one or more portions of the display screen while the game controller attachment is mounted onto the mobile device.

3. The computer-implemented method of claim 1, wherein the set of conductive touch points comprises the rotary wheel, and wherein the computer-implemented method further comprises:
determining the set of game commands by comparing (a) an initial position of a screen contact associated with the rotary wheel and (b) a resulting position of the screen contact associated with the rotary wheel.

4. The computer-implemented method of claim 1,
wherein the set of conductive touch points comprises the sliding element,
wherein the physical interaction includes multiple sequential slides of the sliding element, and
wherein the set of game commands corresponding to the multiple sequential slides comprises a single game command.

5. The computer-implemented method of claim 1, further comprising:
cause display of, on the display screen, instructions defining one or more in-game actions corresponding to the physical interaction.

6. The computer-implemented method of claim 1, wherein the first game state comprises a data structure storing values for game variables associated with at least one of character states, game environment states, or user interface component states.

7. The computer-implemented method of claim 1,
wherein the game application is associated with a physical board game or tabletop game having physical game components including at least one of: game boards, game pieces, figurines, cards, or dice, and
wherein the interaction data received corresponds to manipulation of the physical game components during gameplay.

8. A computer-implemented method for controlling a game application using a game controller attachment removably coupled to a mobile device, the computer-implemented method comprising:
receiving, by a processor of the mobile device, input data from the game controller attachment,
wherein the game controller attachment provides a set of conductive touch points disposed on a housing of the game controller attachment and configured to provide tactile control of the game application,
wherein the housing comprises casing elements configured to structurally support the set of conductive touch points on the housing,
and wherein the game controller attachment partially overlays a display screen of the mobile device that displays a representation of a first game state of the game application;
mapping the input data to a set of in-game actions based on a predefined mapping schema that correlates one or more physical interactions with the game controller attachment to a set of game commands that identify at least one of: (a) directional input, (b) action triggers, or (c) menu selections configured to execute the set of in-game actions on the first game state;
transmitting, via the mobile device, the set of game commands to the game application to receive, from the game application, instructions to generate a second game state; and
updating the display screen of the mobile device to display a representation of the second game state in accordance with the received instructions.

9. The computer-implemented method of claim 8, further comprising:
determining, by the processor, a predefined pressure threshold for a touch to register on the game controller attachment.

10. The computer-implemented method of claim 8,
wherein the housing includes stylizing elements configured to match a game aesthetic that defines one or more visual elements corresponding to the game application, and
wherein the stylizing elements comprise at least one of decorative surfaces, themed textures, character representations, or color schemes that correspond to the one or more visual elements corresponding to the game application.

11. The computer-implemented method of claim 8, wherein mapping the input data further comprises:
accessing, by the processor, a lookup table that correlates specific physical interactions with predefined in-game actions;
identifying, by the processor, a matching entry in the lookup table for the received input data; and
selecting, by the processor, a corresponding in-game action based on the matching entry.

12. The computer-implemented method of claim 8, further comprising:
detecting, by the processor, a change in orientation of the mobile device; and
adjusting, by the processor, the mapping of the input data based on the detected change in orientation.

13. The computer-implemented method of claim 8, wherein the game controller attachment includes a spinning wheel, and the method further comprises:
detecting, by the processor, a rotational speed of the spinning wheel;
determining, by the processor, an in-game action based on the detected rotational speed; and
executing, by the processor, the determined in-game action within the game application.

14. The computer-implemented method of claim 8, further comprising:
detecting, by the processor, simultaneous interactions with multiple conductive touch points, wherein the set of game commands corresponding to the simultaneous interactions comprises a single game command.

15. A game controller attachment configured to be removably coupled to a mobile device, the game controller attachment comprising:
a housing structured to partially overlay a display screen of the mobile device that displays a representation of a first game state of a game application executing on the mobile device;
a fastener configured to secure the housing to at least a portion of the display screen;
a set of tactile controls disposed on a first side of the housing, the set of tactile controls including at least one of: a rotary wheel, one or more control buttons, or a sliding element, wherein each conductive surface is configured to receive physical interaction; and
a set of conductive surfaces disposed on a second side of the housing,
wherein each tactile control configured to cause activation of a corresponding portion of a touch-sensitive interface of the mobile device in response to receiving the physical interaction with one or more tactile controls,
wherein the activation of the corresponding portion of the touch-sensitive interface is configured to execute a set of in-game actions on the first game state of the game application to generate a second game state of the game application, and
wherein, responsive to the generation of the second game state, the mobile device is configured to display a representation of the second game state on the display screen.

16. The game controller attachment of claim 15, wherein:
the housing is configured to cradle the mobile device in an upright position,
the housing includes a support structure that elevates the mobile device at an angle relative to a surface on which the game controller attachment is placed,
the support structure is positioned to orient a front-facing camera of the mobile device towards a user, and
the front-facing camera is configured to capture one or more images of the user at the angle.

17. The game controller attachment of claim 15, wherein the fastener comprises at least one of: a ratchet, an elastic strap, or a clip.

18. The game controller attachment of claim 15,
wherein the rotary wheel comprises a disc with evenly spaced markings, and
wherein the mobile device is configured to detect one or more changes in position of the disc as the rotary wheel rotates.

19. The game controller attachment of claim 15, wherein the sliding element comprises:
a carriage attached to a track, wherein a stylus is configured to extend and retract along the track via the carriage.

20. The game controller attachment of claim 15,
wherein the first side of the housing faces distal to the display screen of the mobile device when the game controller attachment is coupled to the mobile device, and
wherein the second side of the housing faces proximate to the display screen when the game controller attachment is coupled to the mobile device.
